(19) United States
(12) Patent Application Publication
(10) Pub. No.: US 2008/0082451 A1
(43) Pub. Date: Apr. 3, 2008

(54) Biometric Authorization of Electronic Payments

(75) Inventors: Yada Schneider, Camp Verde, AZ (US); Gerald B. Van Wie, Colorado Springs, CO (US)

Correspondence Address: BRENDA L. SPEER;BRENDA L SPEER, LLC, 2 NORTH CASCADE AVENUE, SUITE 1100, COLORADO SPRINGS, CO, 80903, US

(73) Assignee: BioAuthorize Inc., Colorado Springs, CO (US)

(21) Appl. No.: 11/537,618

(22) Filed: Sep. 30, 2006

(51) Int. Cl. G06K 9/00; H04L 9/00; H04K 1/00

(52) U.S. Cl. 705/64; 382/115

(57) ABSTRACT

A method for biometric authorization of an electronic payment between a consumer and a merchant comprising the steps of: (1) a consumer enrollment step for enrollment of a consumer biometric sample, identification information and shipping information and assignment of a unique digital identification number to the consumer; (2) an invoice submittal step for creation of an invoice by a merchant and assignment of an invoice identifier; (3) a consumer notification step regarding a pending invoice; (4) a consumer authentication step by means of a biometric sample; (5) an invoice retrieval step by a consumer; (6) an invoice disposition step by a consumer; (7) a payment authorization step by a consumer; and (8) an invoice payment processing step for processing a payment from a consumer to a merchant.

### BACKGROUND OF THE INVENTION

1. Field of the Invention

The present invention relates to the field of biometrically identifying a consumer for use in connection with the processing of an electronically generated invoice. Specifically, this invention is focused on processing electronic payments between a consumer and a merchant. Types of payments suitable for the present invention are credit card, debit card, electronic check, electronic funds transfer, or any other method wherein the payment method is intangible and capable of electronic processing.

The present invention provides a merchant the ability to generate invoices for any type of goods or services and to specify to a consumer at least one payment type acceptable to the merchant. Additionally, the present invention enables a consumer to provide payment information for an invoice from any computing device which can access the Internet. Furthermore, with the method of the present invention, sensitive consumer information, such as identifying or financial information, is afforded maximum security by reducing the sources to which the information is shared to only one source, which source is referred to herein as a Biometric Invoice Payment System (BIPS).

2. Description of Related Art Including Information Disclosed Under 37 CFR 1.97 and 37 CFR 1.98

Biometric identification devices and methods are known in the prior art. Among the common biometric identification means are fingerprints, palm prints, voice prints, retinal scans and the like. Prior art biometric identification devices, methods and systems are taught by U.S. Pat. No. 5,613,012 issued Mar. 18, 1997, to Hoffman et al. (tokenless, biometric identification of a person combined with a personal identification code); U.S. Pat. No. 5,802,199 issued Sep. 1, 1998, to Pare, Jr. et al. (tokenless, biometric identification of a person combined with a personal identification code); U.S. Pat. No. 5,805,719 issued Sep. 8, 1998, to Pare, Jr. et al. (tokenless, biometric identification of a person combined with a personal identification code); U.S. Pat. No. 5,982,914 issued Nov. 9, 1999, to Lee et al. (identification of a fingerprint biometric using at least one pore and at least one macrofeature of the fingerprint); U.S. Pat. No. 6,131,464 issued Oct. 17, 2000, to Pare, Jr. et al. (biometric measurement of a fingerprint image in combination with finger application pressure on a biometric device); U.S. Pat. No. 6,332,193 B1 issued Dec. 18, 2001, to Glass et al. (generation of a biometric token comprising a digital image of a user); U.S. Pat. No. 6,411,728 B1 issued Jun. 25, 2002, to Lee et al. (identification of a fingerprint biometric using at least one pore and at least one macrofeature of the fingerprint); U.S. Pat. No. 6,591,002 B2 issued Jul. 8, 2003, to Lee et al. (identification of a fingerprint biometric using at least one pore and at least one macrofeature of the fingerprint for use in conjunction with a financial transaction system); U.S. Pat. No. 6,591,249 B2 issued Jul. 8, 2003, to Zoka (use of a biometric identifier in conjunction with a financial transaction system); U.S. Pat. No. 6,871,287 B1 issued Mar. 22, 2005, to Ellingson (identification of a user with a combination of a biometric and an alphanumeric identifier); U.S. Pat. No. 6,985,608 B2 issued Jan. 10, 2006, to Hoffman et al. (tokenless, biometric identification of a person combined with a personal identification code in conjunction with a financial transaction, wherein both a payor and a payee are pre-registered with a transaction system); US Patent Application Publication 2002/0111917 A1 published Aug. 15, 2002, by Hoffman et al. (biometric identification system using an audio signature as a biometric in conjunction with a personal identification number); US Patent Application Publication 2005/0169503 A1 published Aug. 4, 2005, by Howell et al. (fingerprint biometric identification); US Patent Application Publication 2005/0187843 A1 published Aug. 25, 2005, by Lapsley et al. (device for biometric identification in conjunction with a transaction system); US Patent Application Publication 2005/0203841 A1 published Sep. 15, 2005, by Hoffman et al. (biometric identification system using an audio signature as a biometric identifier of a transaction processor); and US Patent Application Publication 2006/0036442 A1 published Feb. 16, 2006, by Novack et al. (biometric verification of an individual's identity in conjunction with a telecommunication system).

The use of biometric identification means in conjunction with the processing of various transactions, such as financial transactions and consumer reward program transactions, is known in the prior art. Prior art biometric identification means in conjunction with transaction processing devices, methods and systems are taught by U.S. Pat. No. 5,838,812 issued Nov. 17, 1998, to Pare, Jr. et al. (tokenless, biometric identification of a person combined with a personal identification code for use of the person's pre-registered financial account information); U.S. Pat. No. 5,870,723 issued Feb. 9, 1999, to Pare, Jr. et al. (tokenless, biometric identification of a person combined with a personal identification code in conjunction with a financial transaction, wherein both a payor and a payee are pre-registered with a transaction system); U.S. Pat. No. 6,192,142 B1 issued Feb. 20, 2001, to Pare, Jr. et al. (tokenless, biometric identification of a person combined with a personal identification code in conjunction with a financial transaction using a registered stored value, or pre-pay, account, wherein both a payor and a payee are pre-registered with a transaction system); U.S. Pat. No. 6,230,148 B1 issued May 8, 2001, to Pare, Jr. et al. (tokenless, biometric identification of a person combined with a personal identification code in conjunction with a financial transaction using a registered checking account, wherein both a payor and a payee are pre-registered with a transaction system); U.S. Pat. No. 6,269,348 B1 issued Jul. 31, 2001, to Pare, Jr. et al. (tokenless, biometric identification of a payor and a payee combined with a personal identification code in conjunction with a financial transaction, wherein both a payor and a payee are pre-registered with a transaction system); U.S. Pat. No. 6,366,682 B1 issued Apr. 2, 2002, to Hoffman et al. (tokenless, biometric identification of a person combined with a personal identification code in conjunction with a financial transaction using a registered financial account); U.S. Pat. No. 6,581,042 issued Jun. 17, 2003, to Pare, Jr. et al. (tokenless, biometric identification of a person combined with a personal identification code in conjunction with an electronic check financial transaction); U.S. Pat. No. 6,594,376 B2 issued Jul. 15, 2003, to Hoffman et al. (tokenless, biometric identification of a person combined with a personal identification code in conjunction with a financial transaction, wherein both a payor and a payee are pre-registered with a transaction system); U.S. Pat. No. 6,662,166 B2 issued Dec. 9, 2003, to Pare, Jr. et al. (tokenless, biometric identification of a person combined with a personal identification code in conjunction with a financial transaction using a registered financial account); U.S. Pat. No. 6,879,966 B1 issued Apr. 12, 2005, to Lapsley et al. (tokenless, biometric identification of a person combined with a personal identification code in conjunction with a financial transaction using a registered financial account, wherein both a payor and a payee are pre-registered with a transaction system); U.S. Pat. No. 6,950,810 B1 issued Sep. 27, 2005, to Lapsley et al. (tokenless, biometric identification of a person combined with a personal identification code in conjunction with a financial transaction using a registered financial account); US Patent Application Publication 2004/0128249 A1 published Jul. 1, 2004, by Hoffman (electronic transaction method using scrip at a point-of-sale for designation as a charitable donation, a rewards program redemption or contribution, or the like); US Patent Application Publication 2006/0006224 A1 published Jan. 12, 2006, by Modi (biometric identification of a person in conjunction with a money transfer service); US Patent Application Publication 2006/0029261 A1 published Feb. 9, 2006, by Hoffman et al. (tokenless, biometric identification of a person combined with a personal identification code in conjunction with a financial transaction using a registered financial account, wherein both a payor and a payee, including a registered payee financial account, are pre-registered with a transaction system); and US Patent Application Publication 2006/0083408 A1 published Apr. 20, 2006, by Hoffman et al. (tokenless, electronic transaction method using biometric identification for the use of scrip at a point-of-sale for designation as a charitable donation, a rewards program redemption or contribution, or the like).

E-commerce is growing at a staggering rate. With the growth in e-commerce has come an even high growth in the proliferation of cyber-crime, including identity theft and online fraud. Current Internet security technology has proven to be ineffective in the prevention of cyber-crime. Many prior art solutions aimed at reducing fraud are too costly to implement.

Victims of identity theft suffer emotionally and financially. Some consumers avoid e-commerce altogether because of the risk of identity theft. Merchants also suffer from cyber-crime. Due to the inherent risks associated with “card-not-present transactions”, e-commerce merchants pay the highest interchange rate.

Financial institutions are losing billions of dollars every year due to fraudulent transactions. Conceding that such losses are a cost of doing business, the financial community plans for fraud by allocating money to cover this loss in their operating budgets.

Accordingly, there is a need for a means by which to conduct safe and effective e-commerce with a highly secure and cost-effective method for authorizing and authenticating e-commerce financial transactions today. Many prior art technologies that have been implemented do little to ensure that the purchase is authentic and/or authorized.

Consumer and business environments which are online, or accessible via the Internet, need a secure method of handling electronic payments between consumers and businesses, as well as between businesses. The present invention provides a secure method for consumer-to-business and business-to-business electronic payment transactions. As used herein, the terminology of “consumer” and “merchant” is understood to encompass both consumer-to-business and business-to-business electronic payment transactions; wherein a “consumer” may be understood to be any party acting as a payor or making a payment and “merchant” may be understood to be any party acting as a payee or receiving a payment.

Traditionally, electronic invoice processing requires a tight coupling between a merchant and a consumer. A consumer is required to provide electronically sensitive personal and financial information to a merchant via a merchant website. In turn, to complete a financial transaction with the consumer, the merchant is responsible to a third party payment processor for the authenticity of the information provided by the consumer. This traditional process is in place for many financial transaction relationships, including, but not limited to, Business-to-Consumer and Business-to-Business transactions.

In the traditional model, the consumer is at risk of submitting sensitive personal and financial data to a merchant or other third party, whose trustworthiness is unknown. Further, the consumer has no knowledge of how his sensitive information is used with regard to information data integrity, security and proper, legal use. The present invention substantially reduces, if not eliminates, the risks inherent in the traditional model, because the present invention requires that the consumer provide sensitive information to only one source, which is secure.

An additional disadvantage of the traditional model is that sensitive information, such as personal and financial data, is stored by multiple data storage entities, such as merchants, third party transaction processors and financial institutions. Multiple data storage entities expose to criminal perpetrators numerous opportunities and sources for potential breach and theft of sensitive information. If these data storage entities are breached, then sensitive information for large numbers of consumers can be stolen. Although prior art methodologies use biometrics as a means to increase security and reduce fraud by authenticating a consumer's identity to a merchant, the prior art has not taught a means to reduce the risk of data breach of data storage entities. A benefit of the present invention is that it does not require the storage of sensitive consumer information which serves to substantially reduce, if not eliminate, the risk of system breach and data theft. A further benefit of the present invention is that it also does not require the registration or storage of sensitive merchant information or account data.

A further disadvantage of the traditional model is that the merchant is responsible for the authentication of the consumer's identity and information prior to entering into a transaction with the consumer. Although there are many tools being utilized currently to mitigate the risk of fraudulent transactions, there has been no complete elimination of fraudulent transactions and the chargebacks associated therewith that are borne by the merchant. The present invention provides the merchant with a guarantee that the consumer has been authenticated through biometric identification, thereby substantially reducing if not eliminating the risk of incurring a fraudulent transaction. Additionally, the present invention relieves the merchant of responsibility for the handling and safeguarding of the consumer's sensitive information.

Consumers and merchants utilize a variety of financial instruments for invoice payments. An advantage of the present invention is that it is not constrained to any specific financial instrument or payment option. In contrast, prior art solutions require the consumer to be associated with a particular financial instrument for payment, and/or the merchant also to be associated with the same particular financial instrument in order to complete a transaction and receive payment. These requirements are burdensome and limit the transactions means between the merchant and the consumer. In contrast, the present invention is not tightly coupled to a particular financial instrument, but rather enables a merchant and consumer to utilize any type of available electronic financial instrument, such as, but not limited to, debit cards, credit cards, electronic funds transfer, electronic checks, stored value cards and any other method of electronic payment. The present invention, therefore, provides a consumer and a merchant with a highly secure and fraud-free method with the flexibility to use and accept and type of electronic payment.

Yet a further advantage of the present invention is that a merchant does not need to register sensitive merchant information or account data with the Biometric Invoice Payment System (BIPS).

Storage of credit/debit account data is an unnecessary security risk for consumers, merchants, third party transaction processors, financial institutions and the like. Anything that is stored can be stolen. If sensitive personal and financial account data for millions of consumers is stored in a central repository, then that repository becomes a prime target for security breach. Rather than store such sensitive information for recall from a storage repository and reuse at the time of a transaction, the present invention does not store sensitive information and requires that the consumer provide this information at the time of payment authorization.

Distribution of sensitive personal and financial information by a consumer to multiple merchants is a further unnecessary security risk and enables cyber-phishing of sensitive, consumer information by unrelated third parties. Additionally, the more parties or entities that have access to, or that come in contact with, sensitive information, the greater the chance for fraud and/or identity theft to occur with the sensitive information.

The present invention satisfies the need for authentic and secure electronic processing of invoices by means of a secure and encrypted online or Internet connection between a consumer and a merchant and by providing a method for biometric identification of a consumer as a prerequisite for processing payment of an electronic invoice from a merchant.

### BRIEF SUMMARY OF THE INVENTION

An object of the present invention is to protect a consumer from identity theft. This objective is accomplished by the method of the present invention by eliminating the requirement for a consumer to pass repeatedly his sensitive information, comprising personal information, financial data and the like, to a merchant website. In the present invention, a consumer need supply this information to only a single secure entity, a Biometric Invoice Payment System (BIPS) as further disclosed herein.

Another object of the present invention is to provide a consumer with the ability to authenticate his identity and to provide payment for a merchant invoice from any biometrically enabled device that has Internet connectivity.

The method of the present invention for biometric authorization of an electronic payment between a consumer and a merchant, comprises the steps of: (1) a consumer enrollment step, wherein a consumer enrolls with a Biometric Invoice Payment System (BIPS) at least one bid biometric sample, consumer identification information and consumer shipping information; further wherein the biometric sample, consumer identification information and consumer shipping information are used to generate and assign a unique digital identification number, or consumer index number, to the consumer (The consumer index number is created by the method of the present invention and assigned to a consumer during enrollment. The consumer index number is used within the method of the present invention as an identification match factor to correlate the consumer's biometric sample to the consumer's identification information, and is not necessarily made known to the consumer.); (2) an invoice submittal step, wherein an electronic invoice is created by a merchant and submitted to said BIPS; further wherein the electronic invoice is used to generate an invoice identifier by said BIPS; (3) a consumer notification step, wherein a consumer is notified by said BIPS that an invoice is pending for the consumer and said BIPS provides to the consumer said invoice identifier; (4) a consumer authentication step, wherein a consumer submits a comparator bid biometric sample to said BIPS for identification and authentication; further wherein said BIPS compares said comparator bid biometric sample with said enrolled bid biometric sample for identification and authorization of the consumer; (5) an invoice retrieval step, wherein an invoice is retrieved from said BIPS by a consumer; (6) an invoice disposition step, wherein a consumer disposes of the invoice by an action consisting of approval or rejection; (7) a payment authorization step, wherein a consumer chooses a financial instrument for payment of said invoice; further wherein the consumer provides to said BIPS a financial instrument choice and requisite information for use of the financial instrument; and (8) an invoice payment processing step, wherein said BIPS uses said invoice identifier and said financial instrument requisite information to process payment from a consumer to a merchant.

The method of the present invention further comprises identification information submitted by a consumer during said enrollment step further enrolls data elements selected from a group comprising a consumer personal identification code (which may be selected from a group comprising a personal identification number, or a consumer password, which password may be any alpha, numeric, or alphanumeric combination), a consumer first name, a consumer last name, a consumer social security number, a consumer birth date, or a consumer secret question and answer.

The method of the present invention further comprises a bid biometric sample submitted by a consumer during said enrollment step further enrolls a bid biometric sample selected from a group comprising a consumer fingerprint, a consumer facial scan, a consumer retinal image, a consumer iris scan, or a consumer voice print.

The method of the present invention further comprises an invoice identifier which consists of data elements selected from a group comprising a merchant invoice amount, a merchant identifier, a merchant invoice number, or a merchant financial account.

The method of the present invention further comprises a consumer authentication step which requires a consumer to specify a consumer personal identification code.

The method of the present invention further comprises a means to capture a consumer bid biometric sample during a consumer enrollment step and to transmit the bid biometric sample to a BIPS.

The method of the present invention further comprises a means to capture a consumer bid biometric sample during a consumer authentication step and to transmit the bid biometric sample to a BIPS.

The method of the present invention further comprises an invoice display step, wherein the invoice is displayed for a consumer with a display means.

The method of the present invention further comprises the selection of a financial instrument from a payment construct group comprising a credit instrument, a debit instrument, an automatic clearing house instrument, an electronic check instrument, a bank draft instrument, a loyalty card instrument, a prepaid card instrument, a reward card instrument, or an electronic funds transfer instrument.

In an alternative embodiment of the present invention, in an invoice submittal step, an electronic invoice is created by a merchant and submitted to the BIPS; further wherein the electronic invoice is used to generate an invoice identifier by the BIPS.

In an alternative embodiment of the present invention, in a consumer notification step, a consumer is notified by a merchant that an invoice is pending for the consumer and the merchant provides to the consumer the invoice identifier generated by the BIPS.

### BRIEF DESCRIPTION OF THE SEVERAL VIEWS OF THE DRAWINGS

FIG. 1 is a diagram showing a personal biometric device connected to a computing device with Internet connectivity.

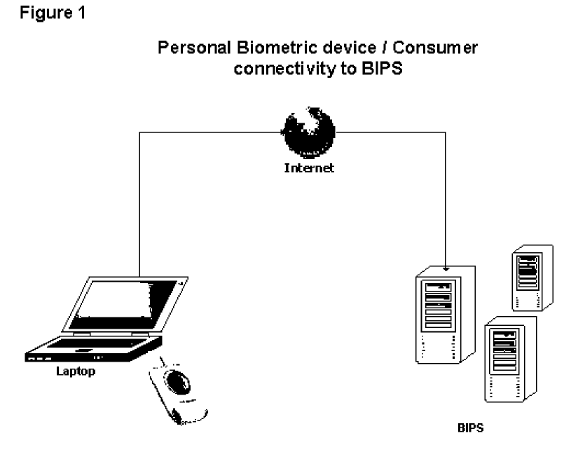

FIG. 2 is a diagram showing a consumer enrolling with a Biometric Invoice Payment System (BIPS).

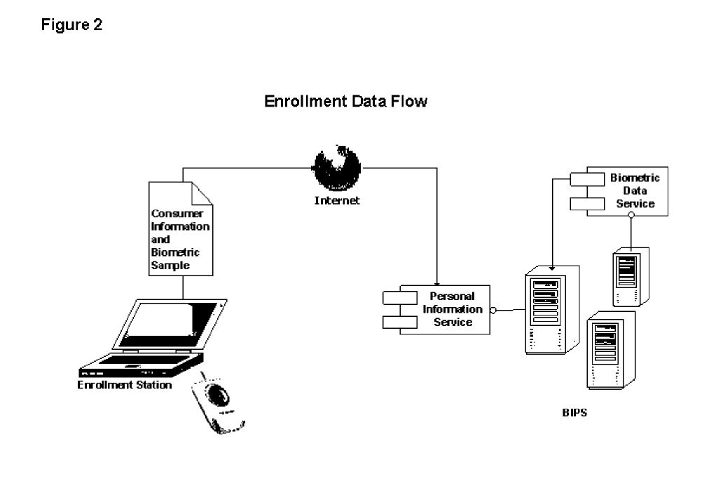

FIG. 3 is a diagram showing a merchant requesting an invoice ID from a BIPS.

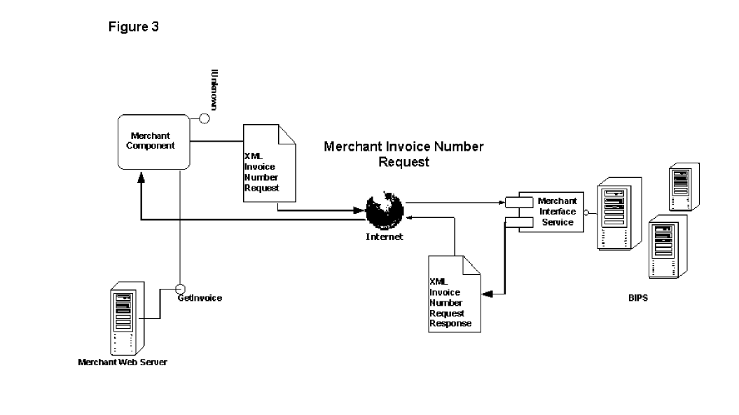

FIG. 4 is a diagram showing a merchant submitting an invoice for processing to a BIPS.

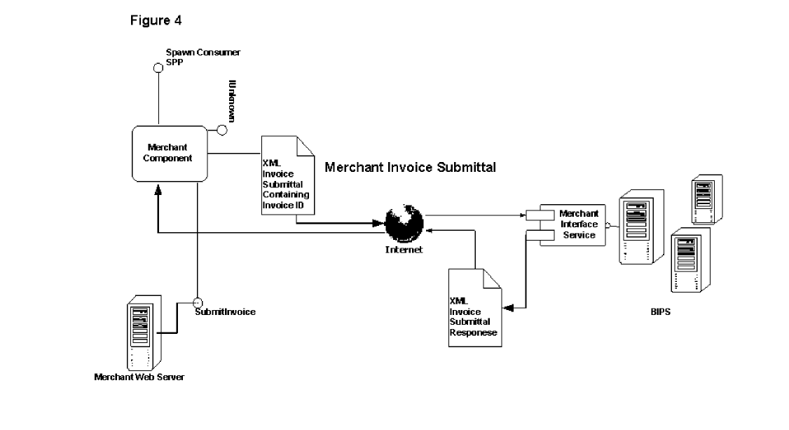

FIG. 5 is a diagram showing a consumer being identified and authenticated by a BIPS.

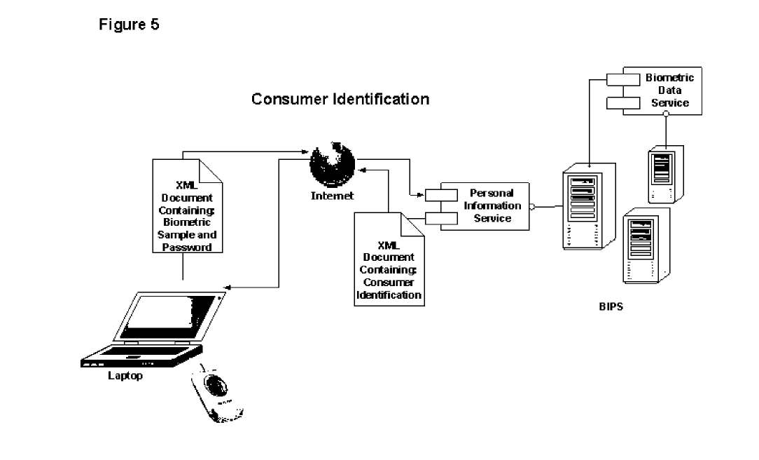

FIG. 6 is a diagram showing the process flow of a consumer paying for a submitted invoice.

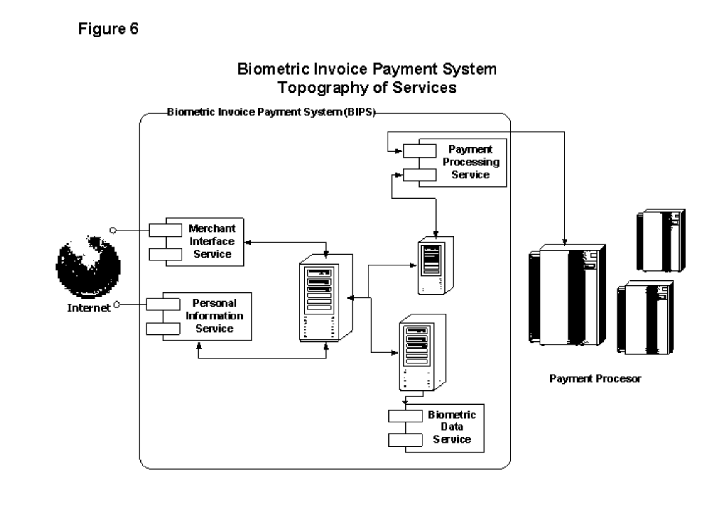

FIG. 7 is a diagram showing the overall process flow of a payment transaction between a consumer and a merchant.

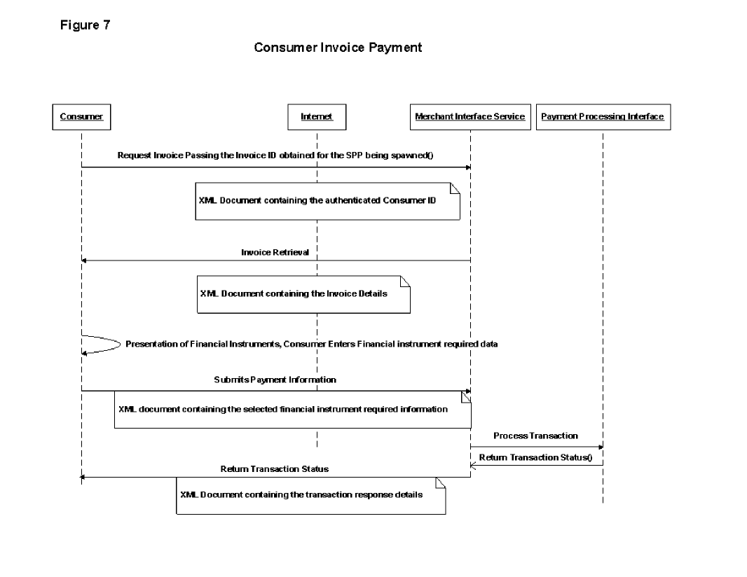

### DETAILED DESCRIPTION OF THE INVENTION

The method of the present invention is for the tokenless biometric authorization of electronic payment between a consumer and a merchant. The method of the present invention comprises the following steps: (a) a consumer enrollment step; (b) an invoice submittal step; (c) a consumer notification step; (d) a consumer authentication step; (e) an invoice retrieval step; (f) an invoice disposition step; (g) a payment authorization step; and (h) an invoice payment processing step.

Prior art authorization systems use various forms of consumer identifiers, such as a shared secret (something the consumer knows, such as a password or personal identification number), a token (something the consumer has, such as a smart card, credit card, etc.), or mutual authentication (a process whereby a consumer identity is authenticated to a target website (or merchant) and a target website is in turn authenticated to the consumer, such as with a private key identifier or use of a secure socket layer). With a tokenless system, such as that of the present invention, a consumer can use identifying information unique to the consumer that is related to something the consumer is, such as a biometric of a fingerprint, a voice print, facial recognition, etc., rather than something the consumer knows or has. The present invention uses the advantages of a tokenless system by using a biometric to identify a consumer.

In the consumer enrollment step, a consumer is enrolled with a Biometric Invoice Payment System (BIPS) by submission of at least one bid biometric sample (which becomes an enrolled bid biometric sample), personal identification information and shipping information. In the preferred embodiment, a consumer enrolled in the BIPS supplies his own personal biometric device. There are many such devices readily available, including, but not limited to, a Microsoft® USB biometric reader, a Microsoft® mouse with biometric reader, or a Microsoft® keyboard with biometric reader. The consumer's biometric device is connected or interfaced to the consumer's personal computer, personal digital assistant or any other device capable of Internet connectivity.

The consumer enrollment process is preferably conducted by a trusted organization such as a banking or financial institution. A trusted organization or authorized enrollment entity might employ an enrollment operator to perform the enrollment. The enrollment operator must have the ability to validate the identity of the consumer, which may be accomplished with any of several validation techniques, such as, but not limited to, the consumer's driver license, social security number, or birth certificate. In a preferred embodiment of the present invention, the enrollment operator may be previously enrolled with the BIPS and authorized to perform a consumer enrollment on behalf of the trusted organization.

Once a consumer has been validated, the consumer is then enrolled with the BIPS, wherein the consumer's personal information is gathered and entered into an Enrollment Interface. The gathered information may be comprised of any combination of the following data elements: first name, middle initial, last name, date of birth, social security number, shipping address, personal identification code, secret question and answer, and the like. The consumer's personal information is encrypted and sent via an XML document to the BIPS. With the consumer's personal information, the BIPS creates a unique database table entry for and assigns a unique digital identification number, or a consumer index number, to the consumer.

The use of a personal identification code is optional; however, in the preferred embodiment of the method of the present invention, multifactor authentication of a consumer is desirable. In the present invention, multifactor authentication is achieved by use of a consumer personal identification code in conjunction with a consumer biometric. The personal identification code can be generated by either a system or a consumer. Furthermore, the personal identification code may or may not be managed by the BIPS. Accordingly, by way of example, a financial institution can use its existing password management infrastructure as part of the multifactor authentication of a consumer in conjunction with the biometric authentication of a consumer by the method of the present invention.

As a further part of the enrollment process, the consumer also scans at least one fingerprint through the use of a personal biometric device attached to the enrollment operator's computer. The consumer's biometric sample is encrypted and sent via an XML document to the BIPS. This biometric sample is then associated with the unique identifier that has been previously assigned to the consumer and stored in the BIPS database table.

The Enrollment Interface is a client-side software program that establishes a connection to the BIPS via Secure Socket Layer TCP/IP. The Enrollment Interface uses a Public Key Identifier (PKI) to ensure that enrollment is performed only by an authorized enrollment entity. An entity that wants to become authorized to perform enrollments is required to request and obtain a public-key certificate from the BIPS.

In an invoice submittal step of the method of the present invention, a merchant requests an invoice identifier from the BIPS. With this merchant invoice identifier, the merchant compiles an invoice, submits the invoice to the BIPS for processing, and passes the invoice identifier to a consumer for retrieval.

In a consumer authentication step of the method of the present invention, a consumer submits a biometric sample (which becomes a comparator bid biometric sample) and a personal identification code to the BIPS for identification and authentication. The biometric sample is processed by a Biometric Data Service for identification and authentication.

In an invoice retrieval step of the method of the present invention, after the consumer is positively identified and authenticated, the consumer requests a merchant invoice that has been previously submitted by a merchant to the BIPS for disposition.

In an invoice disposition step of the method of the present invention, a consumer determines whether to accept or reject the merchant invoice. If the invoice is accepted by the consumer, then the consumer proceeds to a payment authorization step.

In a payment authorization step of the method of the present invention, the consumer selects a supported financial instrument and its associated financial account information and submit to the BIPS the required data for payment of the merchant invoice. The financial instrument is selected from any suitable payment construct, such as, but not limited to, a credit instrument, a debit instrument, an automatic clearing house instrument, an electronic check instrument, a bank draft instrument, a loyalty card instrument, a prepaid card instrument, a reward card instrument, an electronic funds transfer instrument, or the like.

In an invoice payment processing step of the method of the present invention, funds are moved from the account specified by the consumer to an account specified by the merchant by a third party Payment Processing Service (PPS).

Once a consumer is enrolled, he is able to use his personal biometric device to authorize invoice payments using a Single Payment Portal (SPP) application. With SPP an enrolled consumer will no longer have to enter sensitive personal and financial information when “checking out” on a merchant website. Instead, an enrolled consumer can elect to complete his electronic purchase using his biometric identifying data.

The SPP is initiated by an ActiveX control on a merchant's website, which in turn spawns the consumer's instance of the SPP client on the consumer's computing device and passes to the consumer a merchant invoice identifier. The merchant invoice identifier serves as an initiation parameter between the merchant and the consumer to complete a proposed transaction between the merchant and the consumer.

Next, the consumer scans his fingerprint using a personal biometric device. The consumer is then prompted for a personal identification code associated with his BIPS account. An XML document is formed comprised of the password and an encrypted binary template representation of the consumer's fingerprint scan. The SPP encrypts this document with its public key. The encrypted XML document is then sent via SSL over the Internet to the BIPS in order to identify and authenticate the consumer by comparing the supplied biometric sample and password with enrollment data stored in the BIPS database. If the consumer is identified and authenticated by the BIPS, then the consumer's identification information is sent back to the SPP client application, along with any pending merchant invoices for the consumer. A further advantage of the method of the present invention is that when a consumer is multifactor authenticated by both a consumer biometric and a consumer personal identification code, the consumer biometric presented during biometric authentication is stored in the BIPS in association with the authenticated consumer to be used in future authentication attempts, thus providing multiple, cumulative consumer biometric data samples for authentication, which in turn dramatically increases the probability of proper authentication and drastically decreases the probability of a fraudulent authentication attempt.

In the preferred embodiment of the present invention, the SPP is implemented as a client application (or executable file, .exe). This executable file establishes a secure connection between the consumer and the BIPS in order to exchange data between the consumer and the BIPS. The SPP requires a personal biometric device to be present in order to perform consumer identification and authentication. The SPP does not store any data on the consumer's local computing device. The SPP uses a public key obtained from a Certificate Authority (CA) in order to ensure that the data exchange is authentic.

After consumer identification, the SPP presents invoices for consumer review and payment authorization. Upon reviewing the invoice details, the consumer is prompted to pay the invoice, leave it pending, or reject the invoice.

If the consumer opts to pay the invoice, then the consumer is prompted to select payment type and supply required financial information required to complete the purchase. This information is packaged in an XML document, encrypted using the SPP's public key, and transmitted over an SSL connection to the BIPS for payment processing.

If the consumer opts to leave the invoice pending, then the invoice data is associated with the consumer's identity data and stored in a database table on the BIPS to be reviewed by the consumer at a later time.

If the consumer opts to reject the invoice, then the invoice is deleted from the consumer's invoice queue.

In the preferred embodiment of the present invention, the data transmission method between all disparate interfaces or systems is TCP/IP utilizing Secure Socket Layers. The preferred data format used is an XML document.

The BIPS operates and maintains a PKI Certificate Authority. The SPP and Enrollment Interface software components are equipped with a public key that is issued by said CA. This public key is used to encrypt and decrypt data sent and received from the BIPS.

The BIPS is located behind a firewall with direct access to the Internet available only on two publicly defined IP ports for services required. These services are the Merchant Interface Service (MIS) and the Personal Information Service (PIS). Each service has only one port opened respectively for IP communications. If data received on either of these ports cannot be decrypted using the CA's private key, then the connection is purposefully terminated and a log entry is made and associated with the terminated client IP address to ensure a future connection attempt is never permitted from the terminated client IP address. The terminated client IP address is configured in the router to be purposefully rejected in perpetuity.

The BIPS is comprised of PC-based servers that are interconnected on a local area network. In the preferred embodiment of the present invention, the data storage task is performed by a Microsoft® SQL Server or other suitable software and hardware configuration. All backend servers are replicated to another location. The backend systems are comprised of a SQL database server which also run the Biometric Data Service (BDS), Merchant Interface Service (MIS), Personal Information Service (PIS), and payment processing services.

The Biometric Data Service (BDS) is a service application used by the Personal Information Service (PIS) for data access functions. As a service-based application, the application executable accepts IP connections and the reception of XML data. The BDS interface is not directly accessible via the Internet. The BDS receives an XML document containing a binary version of an encrypted biometric fingerprint scan. The fingerprint scan is compared to all of the previously registered fingerprint scans for the consumer. If a match is found, then the unique identifier for that registered consumer is returned. Also, the password that is logged in is validated against the consumer information for that unique identifier.

The Personal Information Service (PIS) is an application-based service that exposes an IP port which is publicly accessible via the Internet. The SPP and Enrollment Interface components communicate with the BIPS by interfacing with the PIS. The PIS receives an encrypted XML document. This document is decrypted using the BIPS's private key. The XML document contains the binary encrypted fingerprint template and the password that has been supplied by the consumer through the use of the SPP.

In the preferred embodiment of the present invention, the payment processing service is a back-end system with no direct connection to or from the Internet. The payment processing service takes information contained in the XML document received from the merchant and the XML document received from the consumer and compiles a packet formatted on the requirements of a payment processing partner. The payment processor is responsible for debiting and crediting of the applicable, respective consumer and merchant accounts to complete the transaction. The status of the transaction is provided to the BIPS and made available to both consumer and merchant via a request based on XML documents.

In the preferred embodiment of the present invention, the merchant control is implemented utilizing an ActiveX control that has three main functions. The first function is to obtain an invoice ID from the BIPS. The second function is to package and submit the invoice to the BIPS. The third function is to spawn the SPP client instance on the consumer's local computing device. This ActiveX control is responsible for the packaging and transmission of XML data between the merchant and the BIPS. All communication between the merchant control and the BIPS is accomplished using the Merchant Information Service (MIS).

The MIS is an application-based service that exposes an IP port which is publicly accessible via the Internet. The merchant control communicates with the BIPS by interfacing with the MIS. The MIS receives an encrypted XML document. This document is decrypted using the BIPS's private key. The MIS enables the following functions to the merchant control: (1) obtain invoice identifier; (2) submit invoice; (3) get invoice status; and (4) get invoice shipping information.

Although the present invention has been described with respect o a particular biometric authorization system and method for its use, it will be appreciated that various modifications of the apparatus and method are possible without departing from the present invention, which is defined by the claims set forth below.

The invention claimed is:

1. A method for biometric authorization of an electronic payment between a consumer and a merchant, the method comprising the following steps:
a. a consumer enrollment step, wherein a consumer enrolls with a Biometric Invoice Payment System (BIPS) at least one bid biometric sample and consumer identification information; further wherein the biometric sample and consumer identification information are used to generate and assign a consumer index number to the consumer;
b. an invoice submittal step, wherein an electronic invoice is created by a merchant and submitted to said BIPS; further wherein the electronic invoice is used to generate an invoice identifier by said BIPS;
c. a consumer notification step, wherein a consumer is notified by said BIPS that an invoice is pending for the consumer and said BIPS provides to the consumer said invoice identifier;
d. a consumer authentication step, wherein a consumer submits a comparator bid biometric sample to said BIPS for identification and authentication; further wherein said BIPS compares said comparator bid biometric sample with said enrolled bid biometric sample for identification and authorization of the consumer;
e. an invoice retrieval step, wherein an invoice is retrieved from said BIPS by a consumer;
f. an invoice disposition step, wherein a consumer disposes of the invoice by an action consisting of approval or rejection;
g. a payment authorization step, wherein a consumer chooses a financial instrument for payment of said invoice; further wherein the consumer provides to said BIPS a financial instrument choice and requisite information for use of the financial instrument; and
h. an invoice payment processing step, wherein said BIPS uses said invoice identifier and said financial instrument requisite information to process payment from a consumer to a merchant.

2. The method of claim 1 further wherein said identification information submitted by a consumer during said enrollment step further enrolls data elements selected from a group comprising a consumer personal identification code, a consumer first name, a consumer last name, a consumer social security number, a consumer birth date, or a consumer secret question and answer.

3. The method of claim 1 further wherein said enrollment step further enrolls data elements consisting of consumer shipping information.

4. The method of claim 1 further wherein said bid biometric sample submitted by a consumer during said enrollment step further enrolls a bid biometric sample selected from a group comprising a consumer fingerprint, a consumer facial scan, a consumer retinal image, a consumer iris scan, or a consumer voice print.

5. The method of claim 1 further wherein said invoice identifier consists of data elements selected from a group comprising a merchant invoice amount, a merchant identifier, a merchant invoice number, or a merchant financial account.

6. The method of claim 1 further wherein a consumer uses a means to capture said bid biometric sample during said consumer enrollment step and to transmit said bid biometric sample to said BIPS.

7. The method of claim 1 further wherein a consumer uses a means to capture said bid biometric sample during said consumer authentication step and to transmit said bid biometric sample to said BIPS.

8. The method of claim 1 further comprising an invoice display step, wherein said invoice is displayed for a consumer with a display means.

9. The method of claim 1 further wherein said financial instrument is selected from a payment construct group comprising a credit instrument, a debit instrument, an automatic clearing house instrument, an electronic check instrument, a bank draft instrument, a loyalty card instrument, a prepaid card instrument, a reward card instrument, or an electronic funds transfer instrument.

10. The method of claim 1 further wherein a consumer may utilize any means capable of capturing a bid biometric sample during said steps of enrollment and authentication and transmitting the bid biometric sample to said BIPS.

11. A method for biometric authorization of an electronic payment between a consumer and a merchant, the method comprising the following steps:
a. a consumer enrollment step, wherein a consumer enrolls with a Biometric Invoice Payment System (BIPS) at least one bid biometric sample and consumer identification information; further wherein the biometric sample and consumer identification information are used to generate and assign a unique digital identification number to the consumer;
b. an invoice submittal step, wherein an invoice identifier is provided to a merchant by said BIPS; further wherein the merchant submits to said BIPS a merchant electronic invoice which is associated with the invoice identifier;
c. a consumer notification step, wherein a consumer is notified by said merchant that an invoice is pending for the consumer and the merchant provides to the consumer said invoice identifier;
d. a consumer authentication step, wherein a consumer submits a comparator bid biometric sample to said BIPS for identification and authentication; further wherein said BIPS compares said comparator bid biometric sample with said enrolled bid biometric sample for identification and authorization of the consumer;
e. an invoice retrieval step, wherein an invoice is retrieved from said BIPS by a consumer;
f. an invoice disposition step, wherein a consumer disposes of the invoice by an action consisting of approval or rejection;
g. a payment authorization step, wherein a consumer chooses a financial instrument for payment of said invoice; further wherein the consumer provides to said BIPS a financial instrument choice and requisite information for use of the financial instrument; and
h. an invoice payment processing step, wherein said BIPS uses said invoice identifier and said financial instrument requisite information to process payment from a consumer to a merchant.

12. The method of claim 11 further wherein said identification information submitted by a consumer during said enrollment step further enrolls data elements selected from a group comprising a consumer personal identification code, a consumer first name, a consumer last name, a consumer social security number, a consumer birth date, or a consumer secret question and answer.

13. The method of claim 11 further wherein said enrollment step further enrolls data elements consisting of consumer shipping information.

14. The method of claim 11 further wherein said bid biometric sample submitted by a consumer during said enrollment step further enrolls a bid biometric sample selected from a group comprising a consumer fingerprint, a consumer facial scan, a consumer retinal image, a consumer iris scan, or a consumer voice print.

15. The method of claim 11 further wherein said invoice identifier consists of data elements selected from a group comprising a merchant invoice amount, a merchant identifier, a merchant invoice number, or a merchant financial account.

16. The method of claim 11 further wherein a consumer uses a means to capture said bid biometric sample during said consumer enrollment step and to transmit said bid biometric sample to said BIPS.

17. The method of claim 11 further wherein a consumer uses a means to capture said bid biometric sample during said consumer authentication step and to transmit said bid biometric sample to said BIPS.

18. The method of claim 11 further comprising an invoice display step, wherein said invoice is displayed for a consumer with a display means.

19. The method of claim 11 further wherein said financial instrument is selected from a payment construct group comprising a credit instrument, a debit instrument, an automatic clearing house instrument, an electronic check instrument, a bank draft instrument, a loyalty card instrument, a prepaid card instrument, a reward card instrument, or an electronic funds transfer instrument.

20. The method of claim 11 further wherein a consumer may utilize any means capable of capturing a bid biometric sample during said steps of enrollment and authentication and transmitting the bid biometric sample to said BIPS.
